(19) United States
(12) Patent Application Publication
(10) Pub. No.: US 2005/0147866 A1
(43) Pub. Date: Jul. 7, 2005

(54) Solid oxide fuel cell sealant comprising glass matrix and ceramic fiber and method of manufacturing the same

(75) Inventors: Haeng Jin Ko, Gyeonggi-do (KR); Hae Weon Lee, Seoul (KR); Jae Chun Lee, Gyeonggi-do (KR); Jong Ho Lee, Seoul (KR); Hue Sup Song, Seoul (KR); Joo Sun Kim, Seoul (KR); Tae Wook Noh, Seoul (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/026,920

(22) Filed: Dec. 29, 2004

(30) Foreign Application Priority Data
Jan. 5, 2004 (KR) 2004-0000278

(51) Int. Cl. H01M 8/02; C03C 14/00

(52) U.S. Cl. 429/36; 501/32

(57) ABSTRACT

Sealant compositions particularly suitable for solid oxide fuel cell sealant are provided and preferably comprise glass matrix and ceramic fiber, wherein glass matrix and ceramic fiber are mixed in an volume ratio of 25:75-75:25 in the sealant, and the ceramic fibers are preferably uniformly dispersed in the sealant to exhibit an orientation. Methods to manufacture the sealant compositions also are provided. Particularly preferred sealant compositions of the invention can efficiently avoid undesired viscous flow of glass matrix, precisely locate the stack of fuel cell on the region to be sealed, and maintain uniform sealing ability under various changes in size of the fuel cell stack.

### CROSS REFERENCE TO RELATED APPLICATIONS

This application is based on, and claims priority from Korean Application No. 2004-0000278, filed on Jan. 5, 2004, the disclosure of which is hereby incorporated by reference.

### TECHNICAL FIELD OF THE INVENTION

This invention relates to a solid oxide fuel cell sealant comprising glass matrix and ceramic fiber, and a method for manufacturing the solid oxide fuel cell sealant.

### BACKGROUND OF THE INVENTION

In a flat solid oxide fuel cell, a sealant positioned between a solid electrolyte and a jointer generally acts as a sealing adhesive to prevent mixing between a hydrogen fuel gas, which is directly supplied to a cathode, and an air gas, which is in contact with an anode. In particular, the sealant should be able to prevent gas leakage under reducing and oxidizing atmospheres at high temperature. The sealant also should provide structural stability without reactivity at each respective interface.

Conventional sealants include glass and crystallized glass; mica and mica-glass composite; glass-filler composite; etc. In particular, in a stack composition comprising a plurality of unit cells, the thermomechanical properties of a sealant can be closely related with the functions of the entire stack as well as the life of the stack. The most commonly used sealants are glass or crystallized glass such as SiO₂.SrO.La₂O₃.Al₂O₃.B₂O₃ and SrO.La₂O₃.Al₂O₃.B₂O₃.SiO₂ which do not exhibit differences in coefficients of thermal expansion with other structural components such as an end cell and a jointer, exhibit a glass transition temperature (Tg) at a temperature below the operation temperature and maintain a sealing ability via viscous flow. U.S. Pat. No. 5,453,331 discloses a method for manufacturing a paste to use as a sealant by adding a proper solvent, an adjuvant, a plasticizer to the above glass or crystallized glass as well as manufacturing a tape as a sealant in the form of a gasket. However, when that glass is used alone, glass sealant may be damaged due to brittle breaks resulting from rapid cooling or repeated heating/cooling. In addition, in the event that glass is prepared in the form of a sealant paste, replacement can be difficult when required due to the damage on the end cell or a sealant.

Mica is also commonly used as a sealant. Mica advantageously can exhibit elastic behaviour at operational temperatures of a solid oxide fuel cell (SOFC), can avoid binding or reacting with other components, and can tolerate expansion and shrinkage during heat cycles. In general, flat mica is manufactured in a form of a gasket to be used as a sealant, and air-tight adhesion is induced by applying a compressed load during the operation.

In prior systems, when viscous flow of glass cannot be restricted within a certain geometrical range, the viscous glass penetrates within the stack thereby reducing the effective space of the end cell and even terminating fuel cell operation. Further, the increase in weight of the stack itself due to the size and capacity of the stack can expedite the viscous glass flow. Thus it can be desirable to restrict the glass to the region where it should be sealed. For this, mica is added or glass is penetrated into a fiber bundle to prevent the viscous flow of the glass.

Meanwhile, when mica is used as a sealant it often results in having a poor sealing ability due to its coarse surface thus requiring an increased level of compressed load for a better sealing effect. The surface coarseness of mica can be improved by using a mica single crystal or by forming glass layers on both sides of mica. However, the manufacturing process is complex and producing the sealant in a multi-layered structure also can be difficult.

Recent studies have focused on developing a sealant in the form of a gasket where flat mica is used as a matrix to which is added either a ceramic fiber or a reinforcing material instead of using glass alone. In such systems, the reinforcing material should serve to provide the sealing effect within the matrix and thermomechanical stability. Further, objectives of such studies are achieving fine glass matrix and the orientation of a reinforcing material having a relatively large geometrical anisotropy. Current technologies in structure planning and manufacturing are far behind in meeting requirements for resolving those objectives.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, the present invention provides a solid oxide fuel cell sealant comprising glass matrix and ceramic fiber, wherein the ceramic fibers are dispersed in the glass matrix. The mixture is preferably heat treated so that the molten glass matrix can fill in or occupy pores between the ceramic fibers while concurrently conferring an orientation on the ceramic fibers. The sealant composition suitably can be formed as desired such as in a shape of a gasket and located thereafter on the region to be sealed e.g. between the layers of each unit cell which forms a stack of a solid oxide fuel cell.

Particularly preferred sealant compositions useful for a solid oxide fuel cells suitably comprise glass matrix and ceramic fiber, wherein a) the glass matrix comprises one or more compounds comprising BaO, Al₂O₃, SiO₂, CaO, TiO₂, ZrO₂ and B₂O₃, and b) the glass matrix and ceramic fiber are mixed in a respective volume ratio (i.e. glass matrix:ceramic fiber) of about 25:75 to about 75:25 in the sealant composition.

In another aspect, the invention provides a method for manufacturing a solid oxide fuel cell sealant, wherein the produced product can efficiently prevent or minimize viscous flow of glass matrix, precisely locate the stack of fuel cell on the region to be sealed, and maintain uniform sealing under various changes of the size of the fuel cell stack.

Other aspects of the invention are described below.

### BRIEF DESCRIPTION OF THE DRAWINGS

The above and other objects and features of the present invention will become apparent from the following description of the invention, when taken in conjunction with the accompanying drawings, wherein:

FIG. 1 is a schematic diagram of a method for manufacturing a solid oxide fuel cell sealant comprising glass matrix and ceramic fiber of the present invention;

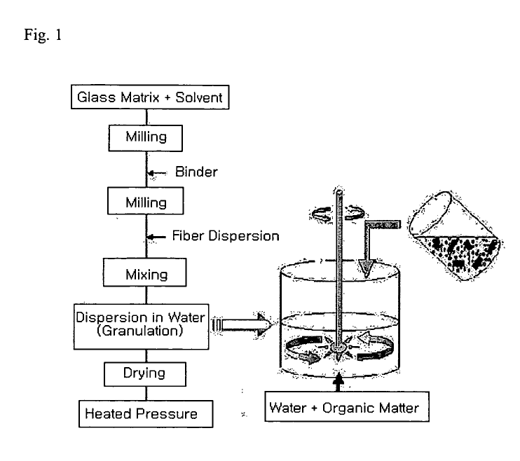

FIG. 2 shows schematic drawings representing the differences in orientation of granules dispersed by thermal spray drying and liquid condensation methods;

FIG. 3 is a schematic diagram of a device for measuring gas leakage rate at high temperature in Experimental Example 2; and

FIG. 4 is a graph showing the sealed state as well as leaking state of a device for measuring gas leakage rate in Experimental Example 2.

### DETAILED DESCRIPTION OF PREFERRED EMBODIMENTS

As stated above, this invention relates to a solid oxide fuel cell sealant comprising glass matrix and ceramic fiber which can ensure high sealing ability, and a method for manufacturing the same. In preferred aspects, systems and methods of the invention can minimize the change in stack dimension during the operation of the stack by optimizing the two-dimensional orientation of the granules of ceramic fiber during hot compacting process. More specifically, the present invention includes a solid oxide fuel cell sealant comprising glass matrix and ceramic fibers, wherein (a) glass matrix which comprises or is made of one or more compounds selected from the group consisting of BaO, Al₂O₃, SiO₂, CaO, TiO₂, ZrO₂, MgO, La₂O₃ and B₂O₃, and ceramic fibers are mixed in the volume ratio of about 25:75 to about 75:25 in the sealant, and (b) the ceramic fibers are uniformly dispersed in the sealant to have an orientation.

Further, the present invention relates to a method for manufacturing a solid oxide fuel cell sealant comprising (a) preparing a slurry by mixing the glass matrix which comprises or is made of one or more compounds selected from the group consisting of BaO, Al₂O₃, SiO₂, CaO, TiO₂, ZrO₂, MgO, La₂O₃ and B₂O₃, and an organic compound or component comprising one or more of a porous ceramic fiber, a filler, a hardener and a plasticizer, followed by a milling process suitably including use of one or more non-aqueous solvents; (b) granulating the slurry such as by dispersing and stirring in one or more suitable solvents; (c) manufacturing a solid oxide fuel cell sealant in a desired pattern by converting the granulates via compressed forming such as under elevated temperature and/or pressure e.g. in excess of 100° C. or 150° C. such as 200° C. and/or under elevated pressures such as pressures of 10-1500 kg/cm² and (d) applying the thus obtained product to a sealing region of the solid oxide fuel cell and removing an organic mixture and exhibiting sealing ability via viscous flow of glass matrix at a cell operation temperature.

In another aspect, a solid oxide fuel cell sealant is provided that comprises glass matrix and ceramic fibers, wherein ceramic fibers are uniformly dispersed in glass matrix and an orientation of ceramic fibers are improved by using granules with low filling density, where direct contact between at least a substantial portion of ceramic fibers (e.g. at least about 10, 20, 30,40, 50, 60, 70, 80 or 90 weight percent of total ceramic fibers present in a sealant composition) is prevented or at least substantially avoided, thereby manufacturing a gasket having a uniform filling structure, and the gasket is precisely located in the sealing region between layers of unit cell and suitably heated preferably under pressure to densify glass matrix via viscous flow.

A preferred embodiment with respect to the components of the glass/ceramic fiber sealant useful for SOFC and related methods are described as follows.

1. Preparation of a Slurry

A slurry is suitably prepared by mixing the glass matrix which suitably comprises or is made by using one or more of BaO, Al₂O₃, SiO₂, CaO, TiO₂, ZrO₂, MgO, La₂O₃ and B₂O₃, and an organic component comprising one or more of a porous ceramic fiber, a filler, a hardener and a plasticizer, followed by a milling process suitably using one or more non-aqueous solvents. Such a slurry comprising the glass and ceramic fiber is processed further so that powdered aggregates are separated and the various components are uniformly mixed.

Preferably, the glass matrix and the ceramic fibers are mixed in a respective volume ratio (i.e. glass matrix:ceramic fibers) of about 25:75 to about 75:25. If the volume ratio is below that preferred range, the ceramic fibers can directly contact each other to a significant extent which can lead to a partial densification of glass matrix via viscous flow. Such partial densification can render difficult completely filling remaining pores which in turn can result in an increase in gas leakage. On the other hand, if the volume ratio is greater than that preferred range, the ceramic fibers content can decrease which can render the desired formation of a mesh-like structure among ceramic fibrous particles more difficult. Further, such a material that has a relatively low volume of ceramic fibers can exhibit excessive viscous flow. As a consequence, such a composition may more readily migrate out of a desired sealing region and thus decrease uniformity of the sealant. In turn, this can decrease the desired thermomechanical properties of the ceramic fibers as well as interfacial flatness and dimensional stability.

Thus, a desired sealant structure includes a strong mesh-like structure among fibrous particles wherein pores formed between the granules are substantially or completely filled via the viscous flow of glass matrix. To meet this objective, preferably the glass matrix and ceramic fibers volume ratio are within the above described preferred ranges and further preferably that the fibrous particles in the sealant are two-dimensionally arranged to minimize the volume ratio. The two-dimensional orientation of the fibrous particles can be significantly influenced by the volume fraction of fibrous particles in the sealant composition as well as the filling density of the mixed granules of the entire components of a sealant.

In one preferred embodiment, a slurry is prepared having a glass matrix:ceramic fibers volume ratio of 25:75 to 75:25. Granules are then produced from that slurry by a liquid condensation method which can provide granules having low filling density through taking advantage of solubility differences between organic binders present in the slurry. This method can produce granules that have inhibited capillary movement, i.e. space can be maintained between granules in the slurry. Admixing the slurry containing such granules with an insoluble solvent can fix organic binders and granules without any or substantially no shrinkage. The slurry may be suitably in the form of drops for admixing with insoluble solvent. The material produced after admixing with insoluble solvent can be dried by removing internal liquid medium without any significant volume change. By adjusting the volume fraction as well as filling density of fibrous particles, the two-dimensional orientation of fibrous particles during the process of compressed forming can be improved.

As discussed above, glass matrix for use as a sealant component in accordance with the invention can be suitably prepared by use of one or more compounds of BaO, Al₂O₃, SiO₂, CaO, TiO₂, ZrO₂, MgO, La₂O₃ and B₂O₃. Preferably, the glass will have a softening temperature of about 600° C. to about 760° C., a glass transition temperature of about 575° C. to about 690° C., and/or a heat expansion coefficient of about 8.0×10⁻⁶/° C. to about 11.8×10⁻⁶/° C. If the softening temperature and glass transition temperature are lower than such preferred ranges, the glass material can deteriorate when employed in a sealant that is exposed to temperatures in excess of 700° C. for extended periods such as more than a year. Such deterioration of the glass material can result in structural damage of the sealant. On the other hand, if the softening temperature and glass transition temperature are in excess of the above preferred ranges, the glass material employed in a sealant can exhibit relatively low viscous flow at sealant operational temperatures of about 700 to about 800° C. thus reducing the sealing effect.

Additionally, the thermal expansion coefficient of the glass component of a glass/ceramic fiber sealant can be important. In at least some embodiments, if the glass thermal expansion coefficient is outside the preferred range of about 8.0×10⁻⁶/° C. to about 11.8×10⁻⁶/° C., the thermal stress resulted from the difference in thermal expansion between the sealant and the region where the sealant is adhered can damage the sealant and thus deteriorate the sealing effectiveness of the sealant.

In certain embodiments, particularly preferred sealant compositions comprise about 35 to about 65 wt % of BaO, about 20 to about 45 wt % of SiO₂, about 3 to about 15 wt % of B₂O₃, about 3 to about 10 wt % of ZrO₂, and about 2 to about 8 wt % of Al₂O₃.

In such particularly preferred compositions, BaO employed in an amount of about 35 to about 65 wt % in the sealant composition can serve to lower the glass melting temperature and increase thermal expansion coefficient. If the BaO content is less than about 35 wt %, the thermal expansion coefficient of glass can become smaller than 10-11×10⁻⁶/° C. (the thermal expansion coefficient of the zirconia electrolyte of SOFC), while if the BaO content exceeds about 65 wt %, the glass melting temperature can increase.

As discussed above, in such particularly preferred compositions, SiO₂ is preferably employed in an amount of about 20 to about 45 wt % in the sealant composition. If the SiO₂ content is less than about 20 wt %, glass formation can become more difficult and heat resistance can be reduced. On the other hand, if the SiO₂ content exceeds about 45 wt %, the glass thermal expansion coefficient can become less than that of the zirconia electrolyte of a solid oxide fuel cell (SOFC).

In such particularly preferred sealant compositions, as discussed above, B₂O₃ is preferably employed in an amount of about 3 to about 15 wt %, which can provide a suitably lowered glass melting temperature as well as provide increased chemical resistance. If the B₂O₃ content is less than 3 wt %, the melting temperature may not be suitably decreased, while the thermal expansion coefficient as well as chemical durability or resistance properties of the glass can become decrease if the B₂O₃ content exceeds about 15 wt %.

As discussed above, in such particularly preferred compositions, Al₂O₃ is suitably employed in a sealant composition in an amount of about 2 to about 8 wt % which can impart increased heat resistance, mechanical properties and chemical durability of the glass. If the Al₂O₃ content is less than about 2 wt %, the such properties of increased heat resistance, mechanical properties and chemical durability may not be significantly increased, while the thermal expansion coefficient of glass can become less than that of the zirconia electrolyte if the Al₂O₃ content exceeds 8 wt %.

In preferred sealant compositions, ceramic fibrous particles or materials suitably have geometric anisotropy with a specific aspect ratio and thus preferably can form a mesh-like structure with relatively high porosity. Particularly preferred ceramic fibrous materials for use in a sealant composition can exhibit good mechanical properties by binding to the glass matrix. Preferred materials employed with ceramic fibrous particles include those which are not directly involved in a chemical reaction at operation temperature of a unit cell such as alumina fiber, mullite fiber, and glass fiber.

The strength, leakage rate, density and/or porosity of the glass/ceramic fiber sealant of the present compositions can be affected by the aspect ratio of the ceramic fibrous particles. Preferably, the aspect ratio ceramic fibrous particles should be in the range whereby the ceramic fibrous particles can be sufficiently dispersed during the granule forming step. In many systems, the aspect ratio of the ceramic fibrous particles is preferably from about 10 to about 200. If the aspect ratio is less than 10, mechanical strength of the sealant and the inhibiting capability of viscous flow of glass resulted from the orientation due to fibers and mesh-like structure can be reduced. If the aspect ratio of the ceramic fibrous particles exceeds 200, formation of a mixed dispersion of the ceramic fibrous particles and the glass matrix can difficult with separation of components becoming possible.

In preferred systems, the granules containing glass matrix and ceramic fibrous particles suitably have a porosity of about 50 to about 95%. If the porosity of the granule is less than 50%, the overall filling density of the sealant can decrease because horizontal orientation of fibrous particles can be difficult to achieve during the compressed forming process due to the direct contact between fibrous particles. Further, use of ceramic fibrous particles with porosity values outside the range of about 50 to about 95% can adversely impact sealing properties due to viscous flow of glass matrix. In particular, the effects of fibrous particle cluster and the neighboring remaining pores can promote thermal stress generated during a heating cycle.

In many preferred systems, the glass matrix and ceramic fibrous particles are suitably mixed with one or more non-aqueous solvents via milling to provide substantially uniform particles. Suitable non-aqueous solvents for mixing with the glass matrix and ceramic fibrous particles include alcohols, which can dissolve organic binders such as phenol and PVB, with preferred alcohols including alcohols having 1 to about 8 carbons such as such as ethyl alcohol, methanol, propanol and butanol. Additional suitable non-aqueous solvents for mixing with the glass matrix and ceramic fibrous particles include ketones such as acetone and the like as well as aromatic solvents such as toluene, xylene and the like, as well as mixtures of such alcohols, ketone solvents and aromatic solvents.

Suitable organic binders employed as a filler can be suitably prepared by mixing one or more thermoplastic resins such as phenol resin (e.g. novolac or poly(vinylphenol)), ester resin (e.g. acrylate-based resin), polyvinyl butyral and/or polyvinyl alcohol. Mixtures containing at least one of a phenolic resin or an ester resin and at least one of polyvinyl butyral or polyvinyl alcohol can provide particularly suitable filler components. Additional optional components of the filler include a thermoplasticizer which can be added to adjust the physical properties of a binder and a dispersing agent can be added to improve dispersing of the glass matrix. Further, the flowability of glass at high temperature can be adjusted by adding powdered oxide particulate such as zirconia particulate.

2. Granulation of a Slurry

As discussed above, the prepared slurry to be granulated can then be e.g. dispersed and stirred such as in one or more solvents.

In this step, a liquid condensation method is preferably employed where a substantially homogeneous slurry is sprayed onto a solvent (includes solvent mixtures) which has no solubility or relatively minimal solubility in a glass matrix such as ethylene glycol, water or a mixture thereof, preferably distilled water with the lowest solubility, so that the organic binder contained in a spray droplet of the slurry can be fixed concurrently with a solvent substitution. Such fixing of the organic binder component of the slurry can inhibit capillary movement of the organic additives as well as the powders in the slurry thus maintaining a substantially uniform mixture of the slurry components and providing that substantially uniform mixture in the prepared granulates.

To manufacture a sealant which can exhibit good air-tightness and thermocycle stability, it can be important that the filling structure of fibrous particles establish a mesh-like structure over the entire or substantial portion of the sealing region with that space being is densely occupied by the glass matrix. Potential defects in sealing integrity may occur as a consequence of non-uniform fibrous sealant particles and therefore the properties of the produced granules can be important. Further, to obtain an optimized sealant structure it may be preferred to add fibrous particles with appropriate volume fraction according to the aspect ratio of fibrous particles, and by manufacturing the granulates after separating the above fibrous particles individually.

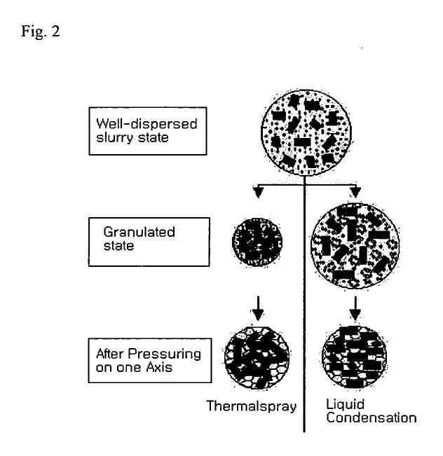

As discussed, preferably granular structures may be condensed in an aqueous environment via liquid condensation. Differences in orientation of the granules can be seen by different methods employed such as thermal spray drying and liquid condensation methods. As shown in FIG. 2, the granules prepared via thermal spray drying may exhibit a relatively decreased orientation after pressure forming such as a resulting from interference of fibers in the granules along with shrinkage of granules during evaporative solvent removal. In contrast, when granules are prepared via liquid condensation, the granular structures uniformly dispersed within the slurry can be well maintained. Further, a relatively low volume fraction of powdered particles in the slurry can lower the filling density of granules thereby minimizing interferences among fiber reinforcing materials. This in turn can provided enhanced two-dimensional arrangement of fibrous particles and increase the sealant filling density during pressure forming.

3. Manufacture of the Granules in a Desired Pattern

Granules as disclosed above may be manufactured in a desired pattern such as through a pressure forming process, which suitably includes conditions of elevated pressure and/or temperature. For instance, the pressure forming process may be conducted as pressures of from about 10 to about 1500 kg/cm² and at temperature of from about 25 to about 200° C.

In preferred pressure forming processes, dried granules are added to a mold which may be suitably of metal construction and pressed to manufacture a sealant in a desired pattern. A step of modifying the water passage can be added, if desired. Preferably, the pressing process is conducted under the above preferred pressure and/or temperatures ranges to impart enhanced properties to the produced glass/ceramic fiber sealant.

The prepared glass/ceramic fiber sealant for a solid oxide fuel cell can have a certain arrangement of the ceramic fibrous particles within the glass matrix by forming after mixing the fibrous particles with glass matrix. Further, the prepared sealant can exhibit good strength due to the organic binder contained in the sealant forming material and thus it is possible to process the sealant to have a desired shape and size. In preferred compositions, the sealant can be trimmed into a desired shape e.g. with suitable cutting tool such as scissors, knife, drilling, etc. In forming a fuel cell stack with a sealant, a unit cell and a separator plate are stacked alternatively and then heat-treated thus removing the organic binder contained in the sealant, and the glass matrix is rendered molten by heating at a higher temperature to thereby impart flowability. The glass behaves as a flowable liquid while the ceramic fibers added as reinforcing material are not flowable but rather substantially fixed and thus serve to maintain the original structure of the gasket. Therefore, flowable molten glass matrices are redistributed in a mesh-like structure comprising fibrous particles and filling in a substantial portion or preferably essentially all of the empty pores thereby enhancing the sealing properties of the sealant.

If glass matrix is used alone without fibrous particles, the glass matrix in a molten state can flow out of the stack particularly through the sides by pressure exerted from both top and bottom surfaces. Accordingly, use of glass matrix alone can provide inferior results.

Preferred sealant compositions as disclosed herein can be employed in various layer thicknesses and provide good sealing properties even upon pressure differences exerted during the course of stack application. In particular, even when viscous flow of glass matrix of a sealant composition occurs, the arrangement of fibrous particles of the sealant composition can undergo corresponding and compensating changes. Further, as discussed above, by reducing the volume fraction of the fibrous particles and glass matrix in a slurry, more porous granules may be produced. Still further, preferred sealant compositions of the invention can accommodate a significant amount of ceramic fibrous reinforcing material to thereby provide enhanced thermo-mechanical stability but without particularly degrading sealing ability.

The present invention will be described in more detail with reference to the following examples, however, they should not be construed as limiting the scope of the present invention.

### EXAMPLES

### Examples 1-5

### Manufacture of Glass Matrix for Sealant

A glass to be used as a component for preparing a glass/ceramic fiber sealant for tight sealing at high temperature by using BaO—Al₂O₃—SiO₂ type glass (“BAS”-type glass hereinafter) was manufactured and the physical properties of thus prepared glass were analyzed. 70 g of the mixed material prepared according to the following Table 1, 35 g of isopropyl alcohol along with 20 zirconia balls with a diameter of 10 mm were added into a 100 cc polypropylene bottle and mixed homogeneously via wet process using a rotational ball mill. The mixed material was then completely dried under vacuum at 80° C. for 5 hr, remelted at 1,450° C. for 2 hr by using Siliconite or Super Kantal electric furnace, and then rapidly cooled down with distilled water to produce the primary glass. The thus prepared glass was pulverized via alumina induction to improve the homogeneity of the above primary glass, remelted at 1,450° C. for 2 hr, poured into a stainless steel mold and then slowly cooled down at the rate of 1° C./min in a leer to produce the mother glass (A) for measuring heat expansion. The glass matrix (B) for manufacturing a gasket was prepared by rapidly cooling the mother glass in distilled water.

TABLE 1

| | Ex. 1 | | Ex. 2 | | Ex. 3 | | Ex. 4 | | Ex. 5 | |
|---|---|---|---|---|---|---|---|---|---|---|
| | wt % | mole % | wt % | mole % | wt % | mole % | wt % | mole % | wt % | mole % |
| B₂O₃ | 8.0 | 11.5 | 5.0 | 7.1 | 6.5 | 9.1 | 11.0 | 15.0 | 19.2 | 26.6 |
| ZrO₂ | 7.8 | 5.8 | 10.8 | 8.7 | 9.3 | 7.3 | 4.8 | 3.7 | 4.8 | 3.8 |
| BaO | 50.5 | 31.7 | 50.5 | 32.4 | 50.5 | 32.1 | 50.5 | 31.2 | 50.3 | 31.6 |
| SiO₂ | 28.7 | 46.2 | 28.7 | 47.0 | 28.7 | 46.7 | 28.7 | 45.4 | 20.7 | 33.3 |
| Al₂O₃ | 5.0 | 4.8 | 5.0 | 4.8 | 5.0 | 4.8 | 5.0 | 4.7 | 5.0 | 4.7 |

The high temperature sealing glass manufactured according to the compositions as shown in the following Table 2 was used to compare the physical properties of glass manufactured in the above examples 1-4, and the results are presented below.

TABLE 2

| | Content (wt %) | | |
|---|---|---|---|
| Classification | Comp. Ex. 1 | Comp. Ex. 2 | Comp. Ex. 3 |
| SiO₂ | 39.8 | 43.5 | 37.0 |
| BaO | 36.5 | 32.3 | 38.0 |
| B₂O₃ | 8.7 | 7.7 | 10.0 |
| Al₂O₃ | 6.3 | 8.8 | 5.0 |
| CaO | 7.0 | 6.2 | 8.0 |
| ZrO₂ | 1.7 | 1.5 | 2.0 |

### Experimental Example 1

### Comparison of Glass to be Used for Manufacturing Sealants

The basic properties of glass were measured: softening point (Ts), glass transition temperature (Tg) and coefficient of thermal expansion (CTE) were measured by using a heat expansion coefficient measuring device (dilatimeter, DIL 402C, Netzsch). Cooled mother glass was processed by using a diamond isomer (Buehler) into the one with 5×5×10 mm and coefficients of linear thermal expansion were measured. The coefficients of linear thermal expansion of mother glass prepared according to various compositions were measured by first installing specimens to be measured along with standard specimen on a push rod, then heating them in an ambient atmosphere under pressure of 15 cN at the rate of 10° C./min until they reach 1,000° C., thereby sensing the minute difference in thermal expansion between the standard specimen and each specimen to be measured using the push rod. The density (ρ) of each of the glass manufactured were measured by using pycnometer (AccuPye 1330, Micromeritrics) using nitrogen gas or distilled water and density bottle, respectively. The results showed that the sealants obtained were very similar in thermal expansion coefficient to those of zirconia electrolytes. Further, heat resistance and crystallization behavior of the glass are different from each other and thus it is expected to be varied to meet various needs in manufacturing SOFC stack by adjusting stack combining temperature.

TABLE 3

| | | | Coefficient |
|---|---|---|---|
| | Softening | Glass | of Thermal |
| | Temp | Transition Temp | Expansion¹⁾ |
| | (Ts, ° C.) | (Tg, ° C.) | (×10⁻⁶/° C.) |
| Ex. 1 | 710 | 630 | 10.6 |
| Ex. 2 | 760 | 689 | 10.1 |
| Ex. 3 | 657 | 594 | 11.2 |
| Ex. 4 | 740 | 674 | 9.7 |
| Ex. 5 | 600 | 575 | 8.0 |
| Comp. Ex. 1 | 698 | 659 | 6.62 |
| Comp. Ex. 2 | 720 | 680 | 6.31 |
| Comp. Ex. 3 | 715 | 670 | 7.27 |

¹⁾Ex. 1-4 show thermal expansion coefficients in the range of 200-500° C., whereas Comp. Ex. 1-3 show coefficients of thermal expansion in the range of 50-300° C.

“BAS”-type glass (Ex. 1-5) having proper heat resistance according to the change in compositions was developed. The above glass are shown to have a relatively greater coefficient of thermal expansion and their values are very similar or equal to those of SOFC components, thus indicating they are useful as a material for manufacturing a sealant. That is, as shown in the above Table 3, the glass prepared according to the examples has relatively higher coefficients of thermal expansion than the glass in comparative examples, and further, the values are very similar or equal to those of SOFC components, i.e., 8.0-11×10⁻⁶/° C. generally coefficients of thermal expansion of SOFC are in the range of 10-11×10⁻⁶/° C.) thus being suitable to be used as a material for manufacturing a sealant.

### Examples 5-9

### Manufacture of a Gasket Using the Glass/Ceramic Fiber Sealant

The “BAS”-type glass prepared in example 3 was pulverized to the size of 1 μm by using a planetary mill (350 rpm, 20 min), a mixture comprising the resulting pulverized glass the compositions of which are shown in the following Table 4, alumina silicate fiber (Al₂O₃:SiO₂=1:1) and 2 wt % of starch solution were mixed in a container for 30 min to form a slurry. The slurry mixture was poured into a forming mold, pressed under 150 kg/cm³ for 10 min to produce a glass/ceramic fiber gasket forming body, and then dried at 80° C. for 12 hr to manufacture a glass/ceramic fiber gasket. The shrinkage rate, apparent density, and apparent porosity of thus manufactured glass/ceramic fiber gasket were respectively measured by using distilled water based on Archimedes' Principle and the results are shown in the following Table 4.

TABLE 4

| | Glass | Ceramic | | Apparent | Apparent |
|---|---|---|---|---|---|
| | (Vol. | Fiber¹⁾ | Shrinkage | Density | Porosity |
| Classification | %) | (Vol. %) | Rate (%) | (g/cc) | (%) |
| Ex. 5 | 100 | 0 | 8.2 | 3.9 | 4 |
| Ex. 6 | 89 | 91 | 7.9 | 3.8 | 10 |
| Ex. 7 | 80 | 20 | 7.4 | 3.6 | 23 |
| Ex. 8 | 73 | 27 | 5.8 | 3.4 | 30 |
| Ex. 9 | 41 | 59 | 0.6 | 3.2 | 43 |

¹⁾The aspect ratio of the ceramic fiber is 50-100.

### Experimental Example 2

### Measurement of Gas Leakage Rate of a Glass/Ceramic Fiber Gasket

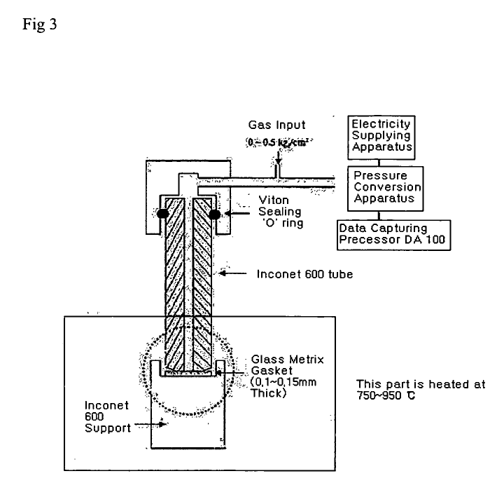

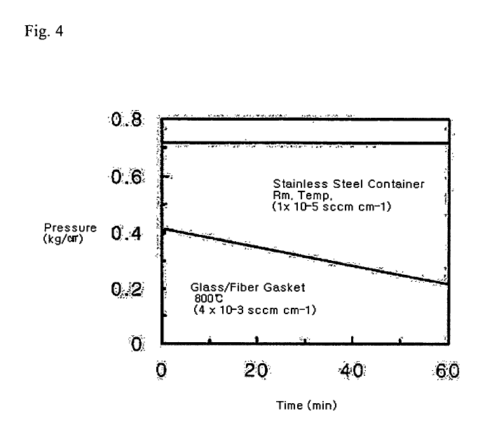

The gas leakage rate at high temperature of the gasket prepared in example 8, wherein the volume ratio between glass and ceramic fiber is 75:25, was measured by using a gas leakage measuring device made of stainless steel as shown in FIG. 3, and the sealed state of the gas leakage measuring device is shown in the FIG. 4. The gas leakage rate per unit length represented by silicon rubber and mica disc sealants are shown in the following Table 5.

TABLE 5

| | Temp. | Gas Leakage Rate |
|---|---|---|
| Classification | Measured (° C.) | (scum cm⁻¹) |
| Silicon Rubber | Rm. Temp | 0.0017 |
| Glass | Rm. Temp | 0.09 |
| | 750 | 0.0017 |
| | 800 | 0.0022 |
| Glass/Ceramic Fiber | Rm. Temp | 0.0047 |
| | 750 | 0.0034 |
| | 800 | 0.0039 |
| | 850 | 0.0039 |
| | 900 | 0.0042 |
| Mica Disc | 800 | 0.03 |

As sown in the above Table 5, the gas leakage rate of the glass/ceramic fiber gasket prepared according to the present invention in less than the 0.03 sccm cm⁻¹.

All documents mentioned herein are incorporated herein by reference in their entirety.

The invention has been described in detail with reference to preferred embodiments thereof. However, it will be appreciated that those skilled in the art, upon consideration of the disclosure, may make modifications and improvements within the scope and spirit of the invention.

1. A solid oxide fuel cell sealant comprising glass matrix and ceramic fiber, wherein(a) glass matrix comprising one or more compounds comprising BaO, Al₂O₃, SiO₂, CaO, TiO₂, ZrO₂ and B₂O₃, and ceramic fiber are mixed in the volume ratio of about 25:75 to about 75:25 in the sealant, and
(b) the ceramic fiber are dispersed in the sealant to have an orientation.

2. The solid oxide fuel cell sealant of claim 1, wherein aspect ratio of the ceramic fiber is in the range of 10 to 200.

3. The solid oxide fuel cell sealant of claim 1, wherein the porosity of granules for pressure forming of the sealant is in the range of about 50 to about 95%.

4. The solid oxide fuel cell sealant of claim 1, wherein the ceramic fiber comprises one or more of alumina, alumina-silica glass fiber, mullite and zirconia.

5. The solid oxide fuel cell sealant of claim 1, wherein at least one filler chosen from among mullite, alumina and zirconia are contained in the amount of about 5 to about 30 wt % in the sealant.

6. A method for manufacturing a solid oxide fuel cell sealant comprising:
(a) preparing a slurry by mixing the glass matrix, which comprises one or more compounds selected from the group consisting of BaO, Al₂O₃, SiO₂, CaO, TiO₂, ZrO₂ and B₂O₃, and an organic component comprising one or more of a porous ceramic fiber, a filler, a hardener and a plasticizer;
(b) granulating the slurry; and
(c) producing a solid oxide fuel cell sealant in a desirable pattern by converting said granulates via compressed forming.

7. The method of claim 6, wherein the slurry is milled prior to granulating.

8. The method of claim 7 wherein the slurry is milled with one or more non-aqueous solvents.

9. The method of claim 8 wherein the one or more non-aqueous solvents comprise one or more solvent selected from alcohols, ketones or an aromatic solvent.

10. The method of claim 8 wherein the one or more non-aqueous solvent comprises one or more solvents selected from methyl alcohol, ethyl alcohol, propyl alcohol, butyl alcohol, acetone or toluene.

11. A sealant composition useful for a solid oxide fuel cell, the sealant composition comprising glass matrix and ceramic fiber, wherein a) the glass matrix comprises one or more compounds comprising BaO, Al₂O₃, SiO₂, CaO, TiO₂, ZrO₂ and B₂O₃, and b) the glass matrix and ceramic fiber are mixed in the volume ratio of about 25:75 to about 75:25 in the sealant.

12. A solid oxide fuel cell stack comprising a sealant of claim 1.

13. A solid oxide fuel cell stack comprising a sealant of claim 11.
